(19) United States
(12) Patent Application Publication
(10) Pub. No.: US 2005/0272464 A1
(43) Pub. Date: Dec. 8, 2005

(54) Wireless communication device having wireless module compatible with wireless communication system

(76) Inventors: Takashi Ishikawa, Tokyo (JP); Katsuhiko Tsunehara, Hachioji (JP); Hirotake Ishii, Hachioji (JP)

Correspondence Address: REED SMITH LLP, Suite 1400, 3110 Fairview Park Drive, Falls Church, VA, 22042, US

(21) Appl. No.: 11/097,293

(22) Filed: Apr. 4, 2005

(30) Foreign Application Priority Data
Jun. 4, 2004 (JP) 2004-166550

(51) Int. Cl. H04B 7/00; H04M 1/00

(52) U.S. Cl. 455/550.1

(57) ABSTRACT

An AD/DA converter is equipped to the wireless communication device main unit side, and a transmission and reception base band filter is equipped to the wireless module side. Due to this arrangement, miniaturization and setting of the cost at a low level of the wireless module replaced for every communication system and the wireless communication device as a total become possible.

### CROSS-REFERENCE TO RELATED APPLICATION

The present application claims priority from Japanese Patent Application No. JP 2004-166550 filed on Jun. 4, 2004, the content of which is hereby incorporated by reference into this application.

### TECHNICAL FIELD OF THE INVENTION

The present invention relates to a wireless communication device comprising a wireless communication device main unit having a software processing unit and a wireless module constructed to be compatible with each wireless communication system.

### BACKGROUND OF THE INVENTION

In general, in the field of a wireless communication, there exist currently various wireless communication systems. Because of the trend to wideband and diversification of the objects and services of communications, it is believed that the increase in the number of wireless communication systems meeting for each application is further accelerated. In each of wireless communication systems, a wireless band, a signal band, and a signal processing method are different for every system to be used. Hence, it is necessary for the user to have exclusive terminals compatible with each of the various types of communication systems and change the systems of his own accord so as to access to various types of services in order to enjoy necessary services.

Under such recent trend, there are ever-increasing needs of selecting an optimum wireless system according to the objects of communications and the condition of communication circumstances, and seamless wireless communication services capable of traversing between the communication systems. For example, in the case of Telematics, a cellular and a wireless LAN for connecting between an automobile and the Internet, an ETC for a toll automatic payment, and a short-distance wireless transmission for communicating inside the automobiles in addition to utilization of ground-based digital broadcasting for enjoying television and wireless are under study. To realize such services, multi-mode wireless terminals are required to adequately be compatible with a plurality of wireless communication systems. Further, accompanied with repeated changes in the wireless standard method and functional additions, particularly in the infrastructure devices such as base station, there are wide-spread needs for wireless communication system capable of easily taking measures to meet subsequent standard changes and functional additions as well as troubles.

As techniques for satisfying the above described requirements, software techniques are being studied in various Research and Development Facilities. In software wireless equipment, the signal processing and protocol control of the wireless communication and the like are executed by a processor having high processing capability. Utilization of a plurality of communication systems can be realized by downloading the software and rewriting it adequately. Further, the change in the wireless standard method and functional addition and trouble of the device can be coped with by amendment only of the software.

To realize the wireless equipment by the software, it is indispensable to equip an analogue-digital converter (A/D converter) for converting a received signal into a digital signal, a digital signal processor for processing the converted signal in accordance with various types of communication system regulations, and a digital-analogue converter (DA converter) for converting the digital signal fabricated by the processor into an analogue signal. In the wireless communication used recently, a PDC uses a 1.5 GHz band, a W-CDMA uses a 2 GHz band, an 802.11b which is a standard of the wireless LAN uses 2.4 GHz band, and an 802.11a uses 5 GHz band, all of which use high frequency wireless signals of GHz order. Hence, to perform software-process for all the processing, a digital signal processor, an AD converter and a DA converter that are of GHz order, high speed and high performance are required. Nevertheless, there does not exist such a high speed high performance processor nor any converter which can meet with such requirement.

Hence, software wireless equipment are under study, in which a wireless unit to perform a processing of the GHz order is modularized for every communication system, and subsequent stages from a base band signal processing are realized by the softer ware. In Japanese Patent Application Laid-Open No. 2003-244759, a wireless communication device is disclosed, which comprises a wireless module and a wireless communication device main unit and prohibits communications by a communication system other than the communication systems usable which are stored in the wireless module in advance so that unnecessary electric wave is not emitted.

### SUMMARY OF THE INVENTION

When taking into consideration software wireless equipment performing communications by using a different wireless module for every communication system as described above, it raises a large problem that in which portion an AD/DA conversion is performed and that in which portion a wireless module and a wireless communication device main unit are separated in a series of signal processing. According to the above described conventional art (Japanese Patent Application Laid-Open No. 2003-244759), the separation is set according to whether or not processing with software is easy, but a clear separation including the AD/DA converter and a base band filter which are indispensable for the construction of the wireless equipment is not made. Hence, in the present invention, the wireless module replaced for every communication system is priced moderately and miniaturized, so that it is an object to provide the wireless communication device construction and separation to reduce the price and scale of the wireless communication device as a total.

As a first construction regarding the present invention, the wireless communication device main unit has a software signal processing section for performing a software signal processing in a baseband band capable of being reconstructed into a communication system desired by the user, and the wireless module has transmission and reception units for transmitting and receiving a wireless signal in a RF band and a frequency converter from the RF band to the baseband band and from the baseband band to the RF band.

To solve the above described problems, in the above described first construction, the present invention is characterized that the wireless communication device main unit comprises an AD converter for converting a received signal from an analogue signal into a digital signal, and a DA converter for converting a transmission signal from a digital signal into an analogue signal in the baseband band, and the wireless module comprises a filter for removing an aliasing from the received signal, and a filter for removing an image signal from the transmission signal.

In the first construction of the present invention, the wireless module is charactering by comprising a storage unit for storing the information which depends on the construction of the module, and the wireless communication device main unit is characterized by reconstituting a software signal processing section based on the information read from the wireless module.

In a second construction in which an external device capable of downloading software required for the communication system is connected, the present invention is characterized in its second feature by comprising a function for reconstituting a software signal processing section based on the information read from the wireless module, a function for downloading the software of the communication system from the external device, and a storage unit for holding the downloaded information on the communication system.

In a third construction in which the wireless module is compatible with one or more communication systems, the present invention is characterized in its third feature by comprising a function for downloading a software for constituting the software signal processing section from the external device as occasion demands, a function for selecting the communication systems, and a function for confirming a connected wireless module number.

In a fourth construction which consists of a wireless communication device main unit capable of mounting a plurality of wireless modules and by one or more modules mounted on the wireless communication device main unit, the present invention is characterized in its fourth feature by comprising a function for changing and using a plurality of modules in addition to a function of downloading software compatible with the communication system to be decided based on the wireless module number.

### BRIEF DESCRIPTIONS OF THE DRAWINGS

FIG. 1 is a first constructional example of a wireless communication device executing the present invention;

FIG. 2 is a constructional example of a software signal processing section mounted on the first constructional example;

FIG. 3 is a communication system list written in a memory 133;

FIG. 4 is a first example of a flowchart up to performing a wireless communication by a first construction;

FIG. 5 is a second example of a flowchart up to performing a wireless communication by a second construction;

FIG. 6 is a third example of a flowchart up to performing a wireless communication by a third construction; and

FIG. 7 is a fourth constructional example of the wireless communication device to execute the present invention.

### DESCRIPTION OF THE PREFERRED EMBODIMENTS

Constructions for executing the present invention will be described below with reference to the drawings. The present invention is not limited to the present embodiments, but can be adaptable if it is a wireless communication device comprising a detachable and attachable module or a replaceable module and a wireless communication device main unit.

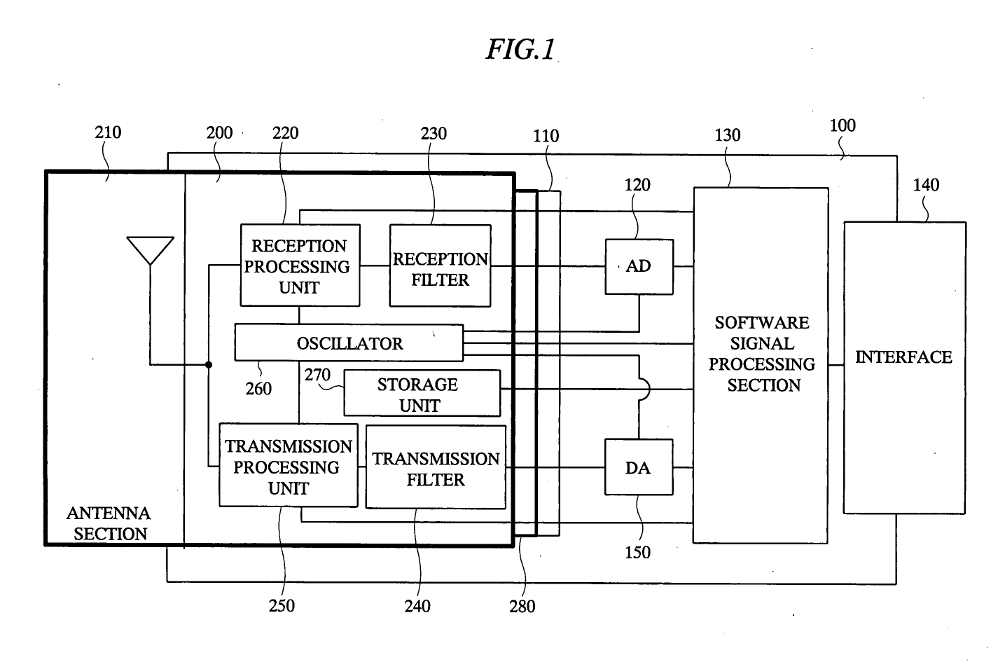

FIG. 1 shows a first embodiment of a first construction of the wireless communication device according to the present invention. The wireless communication device consists of a wireless communication device main unit 100 and a detachable and attachable wireless module 200. The wireless communication device main unit 100 is a portion capable of being compatible with each type of wireless communication systems by changing a software executed by a software signal processing section 130. The wireless modules in the present embodiment and other embodiments are portions constructed so as to be compatible with specific wireless communication system.

The wireless communication device main unit 100 consists of a connector 110, an AD converter 120, software signal processing section 130, an interface 140, and a DA converter 150. The connector 110 is used for physical and electrical connection with a connector 280 at the wireless module 200 side, and is used for input and output of transmitting and received signals, a control signal, a clock signal, and control information. The AD converter 120 is a device for converting an analogue received signal transmitted through the connector 110 into a digital signal. The software signal processing section 130 is a software wireless device for performing a digital signal processing for the received signal and the transmission signal. For example, though it can consists of a FPGA, a DSP, a CPU, a memory and the like, in addition to them, whatever other constructions they are, they are taken as preferable if constructed so as to be able to be compatible with various communication systems. The interface 140 is an interface for connecting the wireless communication device and an external device. The wireless communication device main boy 100 performs a control and an exchange of information from the outside such as a personal computer and the like through this interface. As the interface to be used, whatever construction it is, it is taken as preferable if the interface is capable of exchanging information for controlling such as a USB, a wireless LAN interface, and the like which are used as a standard regulation. The DA converter 150 is a device, which converts a digital signal fabricated at a software signal processing section in accordance with the communication system regulation into an analogue signal. The converted signal is transmitted to the wireless module 200 through the connector 110.

The wireless module 200 consists of an antenna section 210, a reception processing unit 220, a reception filter 230, a transmission filter 240, a transmission processing unit 250, an oscillator 260, a storage unit 270, and a connector 280. The antenna section 210 is an antenna for transmitting and receiving a high frequency wireless signal. The reception processing unit 220 is a portion for processing a received high frequency received signal, and performs a low noise amplification of the received signal, and a frequency conversion and the like from a high frequency (RF: Wireless Frequency) band to a intermediate frequency (IF: Intermediate Frequency) band and a base band (BB: Base Band). The reception filter 230 is an analogue low path filter (LPF: Low Pass Filter) for anti-aliasing for preventing an aliasing noise from going back to a signal band in case the received signal is AD-converted. The transmission filter 240 is an analogue LPF for removing an image frequency component from the DA converted analogue transmission signal. The transmission processing unit 250 frequency-converts a signal which is DA-converted and band-limited by the transmission filter 240 into a high frequency signal for being carried out as a wireless, and amplifies the signal to a necessary level so as to be outputted to the antenna section 210.

Further, the transmission processing unit 250 is subjected to the control of a transmitting power based on a receiving power calculated by the software signal processing device 130 and the like. The oscillator 260 has a crystal oscillator, which is a PLL (Phase Locked Loop) circuit for supplying a frequency suitable for the wireless communication system. The software signal processing section 130 sets a necessary oscillating frequency for the oscillator 260 based on a communication system read from the storage unit 270. Upon receipt of the oscillating frequency, the oscillator 260 outputs a local oscillating frequency to the reception processing unit 220 and the transmission processing unit 250, and outputs a sampling clock and the like to the AD 120 and the DA 150, and the software signal processing section 130. Further, the oscillator 260 receives a fine adjustment of the oscillating frequency from the software signal processing section 130 in the wireless communication device main unit 100. The storage unit 270 is consists of a storage device, and is stored with information to be delivered to the wireless communication device main unit 100 from the wireless module 200.

The connector section 280 is used for physical and electrical connection with the connector 110 at the wireless communication device main unit 100 side, and is used for input and output of transmitting and received signals, a control signal, a clock signal, and control information. Although the present embodiment relates to a wireless communication device of a direct conversion system for directly frequency-converting a RF signal into the baseband band, whatever conversion system or construction it is, it is taken as preferable if compatible with the communication system. The signal processing of the IF band in the case of a heterodyne system through the intermediate frequency is performed in the software signal processing section (130) of the wireless communication device main unit 100 side in the case of the digital processing, and is performed in the reception processing unit (250) and the transmission processing unit (260) of the wireless module 200 side in the case of the digital processing.

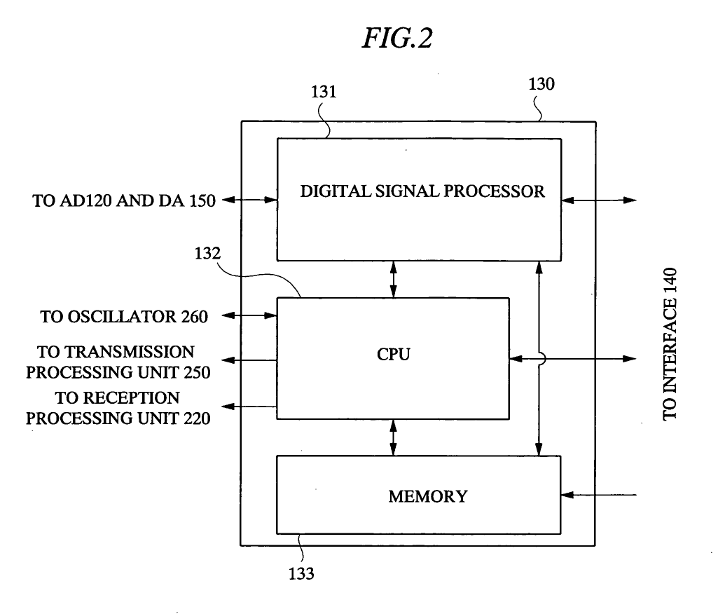

FIG. 2 shows a constructional example of the above described software signal processing section 130. The software signal processing section 130 consists of a digital signal processor 131, a CPU 132, and a memory 133. The digital signal processor 131 consists of a device capable of various processing by rewriting software-wise such as a FPGA (Field Programmable Gate Array), a DSP (Digital Signal Processor), and the like. At the reception, it performs the processing of the received signal inputted from the AD converter in accordance with the regulation of the communication system. To cite one example, according to the 802.11b of the wireless LAN standard regulation, a detection processing such as a digital filter processing, a despreading, a delayed detection, a descramble, and various types of data and control fields is performed in order. Further, when transmitting, the processing of various types of transmitting information inputted from the CPU 132 is performed in accordance with the regulation of the communication system.

To cite one example, according to the 802.11b, the preparation of data and control fields and the construction of a frame, a scramble, a spreading, a digital filter processing, and the like are performed in order. Being not limited to a construction capable of performing all these processing without rewriting, the construction which rewrites them for every transmitting and receiving such as a transmitting system signal processing and a receiving system signal processing is taken as preferable. Further, in the transmitting system as well as in the receiving system, a construction is taken as preferable in which not only all the signals are processed once for each system, but the processing is divided, and the rewriting is performed for each divided processing. Further, at the changing over of each system and processing, a construction is made such that various types of information before changing can be stored in the memory 133 and fed back after the changing.

The CPU 132 reads a software of the communication system from the memory or the external device connected to the interface 140, and processes the transmission and received data in accordance with the regulation of the communication system, and performs the input and output of the data to the digital signal processor 131. Further, the CPU 132, at the time of transmission, performs a transmitting power control for the transmission processing unit 250 in accordance with the regulation of the communication system. Further, the CPU 132 fine-adjusts a local frequency used in the reception processing unit 220 and the transmission processing unit 250 for the oscillator 260 by feedback using the received signal, and performs synchronizing acquisition and synchronizing retention. Further, the CPU 132 performs a setting of a clock signal used in the wireless module 200 and the software signal processing section 130, and a sampling frequency used in the AD converter 120 and the DA converter 150. Further, the CPU 132 is constructed so as to be able to read the wireless module information described in the storage unit 270. Further, the CPU 132 performs the changing control of a software for the digital signal processor 131 and gives a changing timing to the digital signal processor 131. A construction may be such that the changing control is performed by mounting an exclusive device separately on the wireless communication device main unit.

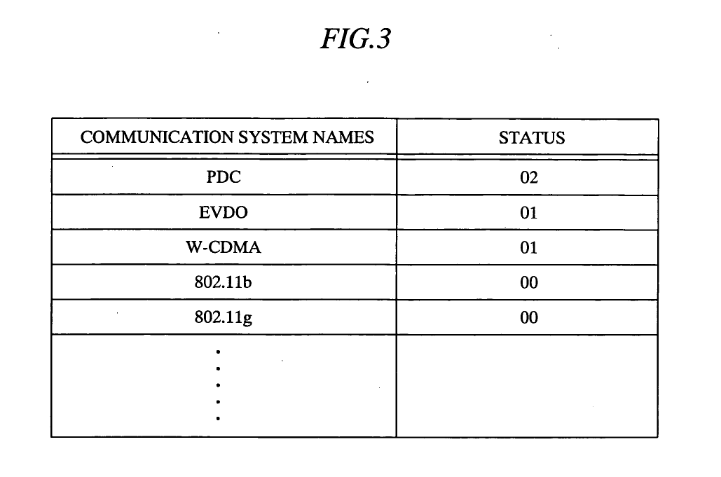

The memory 133 is written with a software for performing the signal processing of various types of communication systems. The software is read by the CPU 132 and the digital signal processor 131 by the control of the CPU 132. Further, the memory 133 holds the communication system list as shown in FIG. 3. The communication system list is written with a communication system name and the communication system status. For example, the communication system status is written as 00 if the communication system does not exist on the memory 133, and if it exists, as 01. In case the communication system is constructed in the digital signal processor 131, the status is written as 02. In case it is connected to the corresponding wireless module, and is constructed in the digital signal processor 131, the status is written as 03, and in case it is not constructed, the status is written as 04. The name of the communication system may be a reference numeral or a number if the wireless module side corresponds to the wireless communication device main unit side on a one for one basis. Further, it does not matter whatever description it is, if the status of the communication system can be recognized. The communication system list is changed in the written content upon receipt of the instruction of the CPU 132 when the power source is turned ON or reset or the digital signal processor is reconstructed. Further, the memory 133 is constructed such that information on the digital signal processor can be temporarily stored.

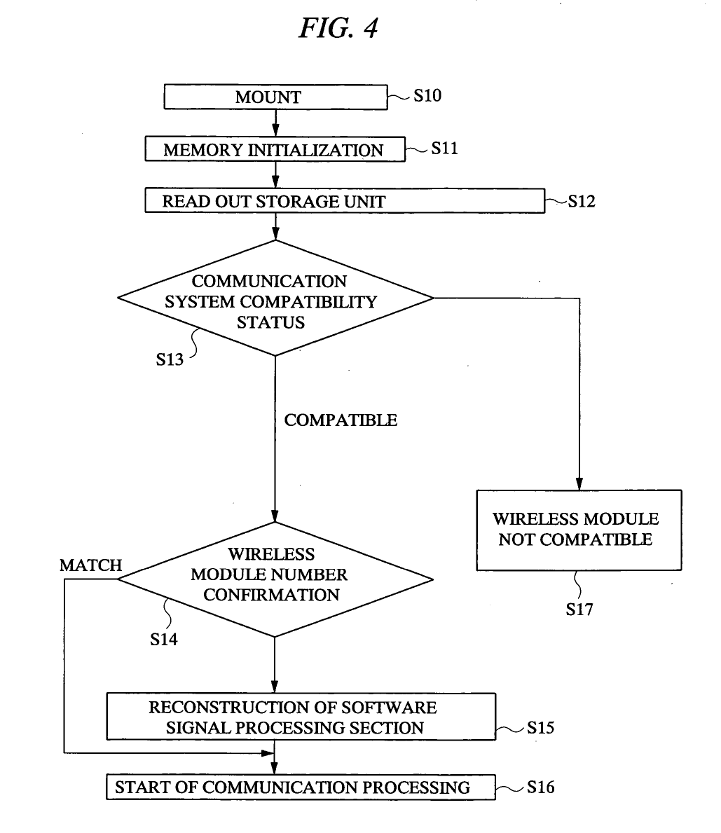

In the wireless communication device of the above described first construction, one example of a first setting procedure from mounting the wireless module 200 which corresponds only to a single communication system on the wireless communication device main unit 100 up to performing a communication processing by the single communication system will be described. FIG. 4 shows a transition view of the setting procedure.

Step 10 shows a state in which the connector 280 of the wireless module side and the connector 110 of the wireless communication device main unit side are connected, and the power source is turned ON or reset. At Step 11, the initialization of the CPU 132 and the initialization of module information written in the memory 133 to be described later at Step 12 are performed. At Step 12, the reading of the wireless module information written in the memory 270 by the CPU 132 is performed, and it is written in the memory 133. As the wireless module information, for example, the following can be cited.
Information 1. Wireless module number
Information 2. Types of communication systems capable of wireless communication by the wireless module
Information 3. Intrinsic irregularity and the like of the wireless module
Information 4. Signal band of each communication system
Information 5. Cut off frequencies of a reception filter and a transmission processing unit
Information 6. Minimum over-sampling multiple number

The information 1 shows an intrinsic number of the wireless module, and the same number is given to the same type of the wireless module by the same producer. The information 2 shows a type of the communication system capable of communications by the wireless module. If the communication system can be specified, any of the name of the communication system or the corresponding number may be preferable. The information 3 shows an irregularity in the production of analogue parts mounted in the wireless module, a temperature characteristic, a voltage characteristic, and the like. The information 4 to 6 are the information required to be commonly owned by the wireless communication device main unit 100 and the wireless module 200 because of the separation effected between the receiving filer 230 and the AD converter 120 and between the transmission processing unit 240 and the DA converter 150. By the combination of the signal band of the communication system and the reception filter 230 as well as the transmission processing unit 240, the least sampling frequency is decided. There is no need to store all the information 4 to 6, but whatever combination it is, if it is the combination that can decide the least sampling frequency such as the combination of the information 4 and 5, and the information 4 and 6, and the information 5 and 6, it is preferable.

At Step 13, the CPU 132 confirms in what state the communication system to be written in the information 2, which is read into the memory 133 at Step 12, is confirmed from the communication system list on the memory 133 in the wireless communication device. In case that the communication system is already reconstructed in the digital signal processor 131 or the software compatible with the communication system exists on the memory, the process advances to Step 14. In case that the communication system does not exist in the communication system list or the software of the communication system does not exist on the memory 133, the process advances to Step 17. At Step 14, in case the communication module number is equal to the wireless module number written in the communication system list, the process advances to Step 16, and in case the number is not equal, the process advances to Step 15. At Step 15, based on the software of the communication system stored on the memory 133, the multiple number of over-sampling decided by the information 3 to 6 stored in the memory at Step 12, and the like, the digital signal processor 131 is reconstructed.

In case that the communication system is already reconstructed in the digital signal processor, at Step 12, based on the information 3 to 6 stored in the memory, the change of a parameter is performed. At Step 16, based on the reconstructed software signal processing section 130, the communication system processing is started. Step 17 is a Step where the communication processing is not performed, but it is waited that next wireless module is mounted and that the power supply is turned on. In case that the external device or the wireless communication device itself has transmitting means such as a display, an audio output and the like, it is made known that the wireless module is non-correspondent or the replacing of the wireless module by showing the corresponding communication system or the downloading of a communication system software is required.

According to the wireless communication device in case of the above described first construction, the AD/DA converter is mounted on the wireless communication device. Hence, the wireless module can be set at a low cost and miniaturized. Further, since a plurality of communication modules are required to realize a plurality of communication systems, the setting of the cost at a low level and the miniaturization become possible for the wireless communication device as a total.

Further, in the present embodiment, the reception filter is provided for the wireless module side. If the reception filter is provided for the wireless communication device main unit side, the reception filter capable of being compatible with various types of communication systems and a variable filter for covering a wide range of cut off frequencies is required, while in the case of the communication system requiring the cut off frequencies not coverable, the communications become impossible or low in accuracy. By providing the receiving filer for the wireless module side, it is possible to design a reception filter dedicated to each communication system, and highly accurate communications are made possible.

Further, the present embodiment provides the transmitting filer for the wireless module side. If the transmission processing unit capable of being compatible with various type of communication systems is disposed at the wireless communication device main unit side, similarly to the case of the reception filter, a variable filter for covering a wide range of cut off frequencies is required. However, in case the cut off frequencies not coverable are required, means of not performing the processing of the communication system is built-in so that the communication processing is not allowed to be performed or an unlawful electric wave ends up being emitted. By providing the transmission processing unit for the wireless module side, it is possible to design a transmission processing unit dedicated to various types of communication systems, and highly accurate communications are made possible without the unlawful electric waves emitted.

Further, by providing an oscillator for the wireless module side, it is possible to prevent a high frequency signal from deteriorating due to pulling around of the wiring. Further, since communications are made only by the communication system matching to the wireless module, no unlawful electric wave is emitted. Further, since the digital signal processing device is reconstructed based on irregularity information on the high frequency wireless section including transmitting and reception filter characteristics and an antenna, highly accurate communications can be made.

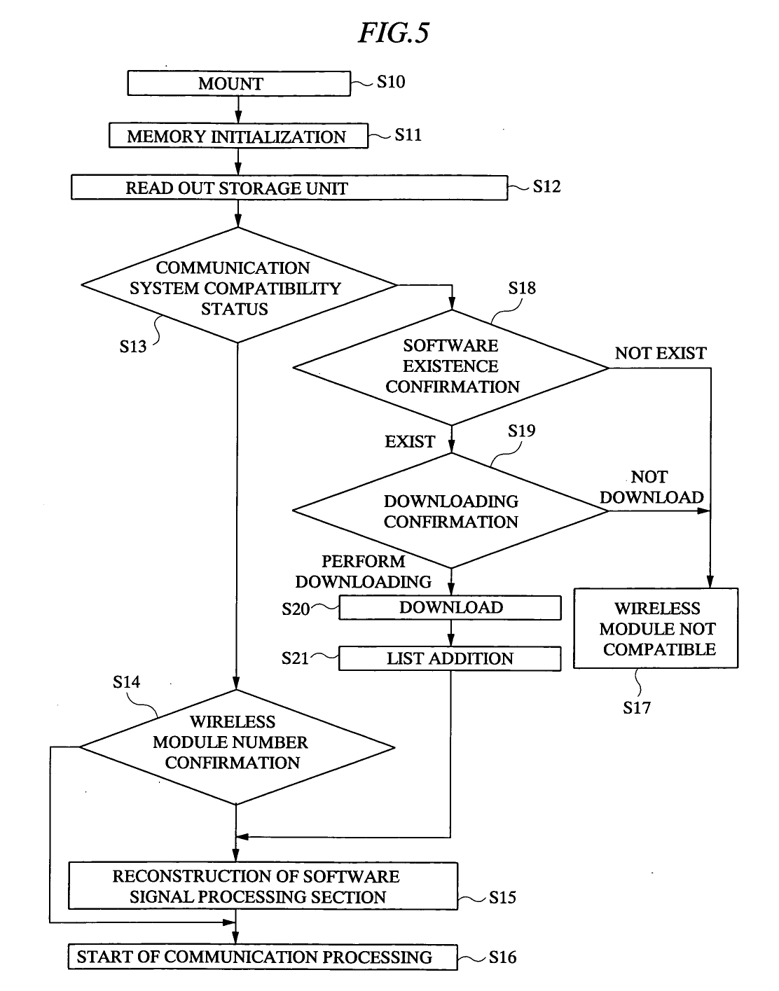

Next, in addition to the first construction, an embodiment of a second construction connected to the external device such as a personal computer and the like, which can download the software compatible with the communication system to be required, will be shown. The second construction of the wireless communication device is the same as the first construction. One example of a second setting procedure from mounting the wireless module 200 which is only compatible with a single communication system on the wireless communication device main unit 100 up to performing transmitting and receiving of the communication system will be described referring to FIG. 5.

Steps 10 to 17 are the same as the first construction. Step 18 is a step in which whether or not the external device holds the software of the communication system is confirmed or whether or not the downloading of the software of the communication system is possible through the network is confirmed in case the external device to be connected to the network such as an internet and the like is connected. In case that the downloading is possible, the process advances to Step 18, and in case it is not possible, the process advances to Step 16. Step 19 is a step in which whether or not the downloading is made in case the software exists on the network. At Step 20, the software is downloaded into the memory 133 from the external device itself or the network connected through the external device. At Step 21, the downloaded communication system is written on the communication system list existing on the memory. In this manner, subsequent to the above described processes, by using the software existing on the memory 133, the communication system can be reconstructed.

According to the wireless communication device according to the above described second construction, even in case that the software of the communication system corresponding to the wireless module mounted on the software signal processing section 130 is not carried, the software of the communication system is downloaded from the external device itself or the network through the external device, thereby making the communication processing possible.

Next, in addition to the second construction, an embodiment of a third construction compatible with the communication system having one or more wireless modules 200 will be shown. In the third construction, the storage unit 270 has a system characteristic parameter (information 7) compatible with each communication system in addition to six pieces of the above described information. The system characteristic parameter is an analogue device setting parameter characteristic to each communication system. By giving this parameter to the analogue devices of the reception processing unit 220 and the transmission processing unit 250, the processing characteristic to the communication system can be performed. Further, the storage unit 270 holds one or more information (at least any one of 1 to 8) compatible with the communication system capable of communications by the wireless module. The CPU 132 issues an instruction to select the communication system for the CPU 132 through the external device in case plural pieces of information are read.

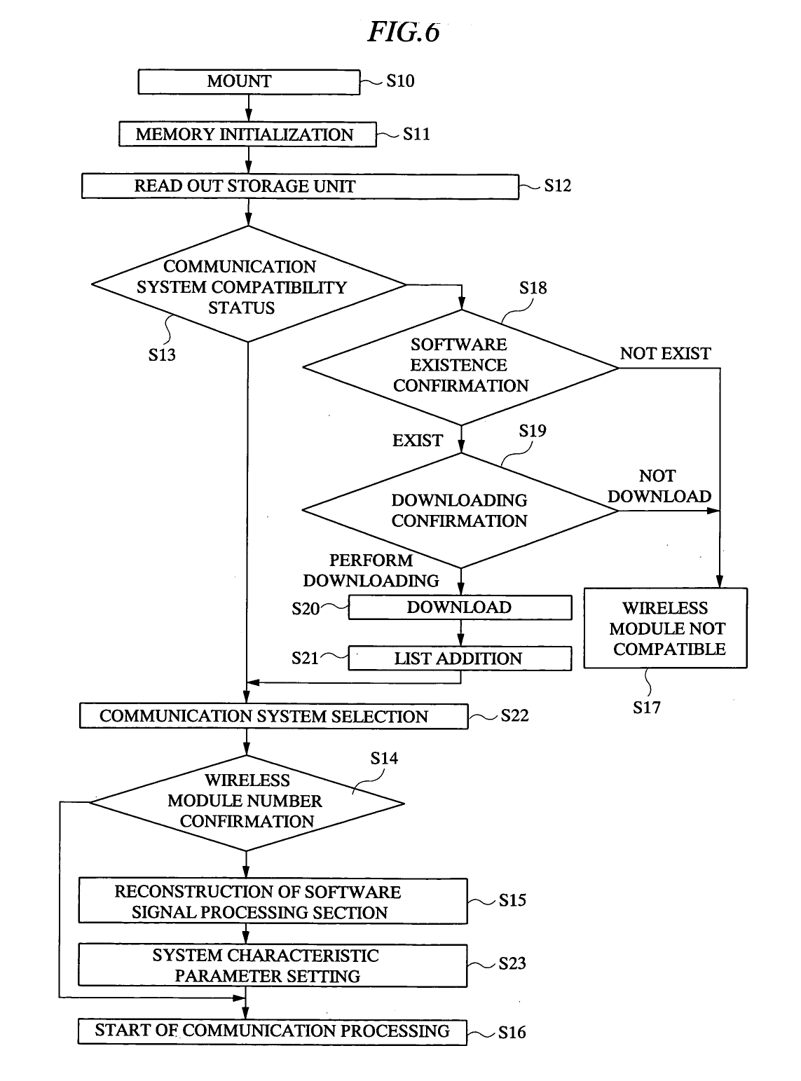

Here, a third embodiment starting from mounting the wireless module 200 compatible with one or more communication systems on the wireless communication device main unit 100 up to performing the communication system processing will be described by using FIG. 6.

Steps 1, 2, and 15 to 17 are the same as the second construction. At Step 12, the CPU 132 reads information on the number of communication systems from the memory 270. At Step 13, in case that the communication system state has been already reconstructed or exists on the memory, the process advances to Step 22, and if not, the process advances to Step 18. This is repeated by the number of communication systems written in the communication system list. In case that there does not exist a communication system advancing to Step 22, and moreover, there does not exist all the software at Step 18, the process advances to Step 17. Further, in case that there does not a communication system advancing to Step 22, and moreover, all the communication systems downloadable at Step 19 are not downloaded, the process advances to Step 17. At Step 20, the software of the communication system selected at Step 19 is downloaded to the memory 133 from the external device itself or the network connected through the external device. At Step 21, the downloaded communication system is written on the communication system list existing in the memory 133.

At Step 22, a communication system for performing the communication processing is selected from the communication system list. The CPU 132 transmits the communication system corresponding to the wireless module connected from the communication system list to the external device. The external device has a construction to select the communication system to perform the communication processing from the transmitted communication systems. The communication system may be selected through a keyboard even if automatically selected. At Step 14, in case the already selected communication system finishes being reconstructed, and moreover, the wireless module number is the same, the process advances to Step 16. Step 23 is a Step of setting a system characteristic parameter. The CPU 132 reads information written in the memory 133, and performs an adequate setting for each analogue device of the reception processing unit 220 and the transmission processing unit 250. In this manner, the wireless module can perform the processing of the communication system.

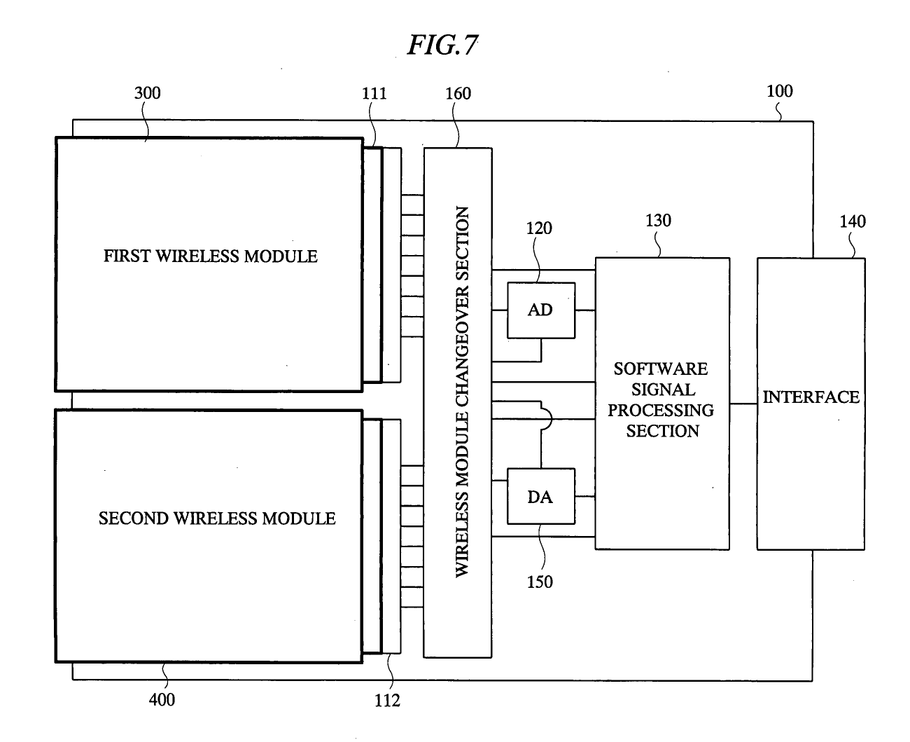

Next, in addition to the third construction, the embodiment of a fourth construction connectable to one or more wireless modules 200 will be shown. One example of the construction according to the fourth construction is shown in FIG. 7. A wireless communication device main unit 100 has two connectors (111 and 112). In this manner, the wireless communication device main unit 100 can connect a plurality of wireless modules. Further, a wireless module changeover section 160 electrically performs a changeover of the wireless module by the control of a CPU 132. Hereinafter, a first wireless module 300 compatible with a plurality of communication systems, and a second wireless module 400 compatible with a plurality of communication systems are mounted on the wireless communication device main unit 100, and a fourth embodiment up to performing a communication system processing will be described. A state transition view same as FIG. 6 is used.

Steps 10, 11, 16, 17, and 20 to 23 are the same as the third embodiment. At Step 12, a CPU 132 changes over the wireless module changeover section 160, and reads information 1 to 8 from a memory of the wireless module in order of a small slot number. At Step 13, the CPU 132 performs a confirmation of the communication system adaptation status of the wireless module of a young slot number (fist wireless module 111) similarly to the third embodiment. Next, the CPU 132 changes over the wireless module changeover section 160, and performs a confirmation of the communication system adaptation status of the next wireless module (second wireless module 112) similarly to the third embodiment. At Step 18, the CPU 132 performs a confirmation of the existence of the software for the wireless module (first wireless module 111) of a young slog number similarly to the third embodiment. Next, the CPU 132 changes over the wireless module changeover section 160, and performs a confirmation of the existence of the software for the next wireless module (second wireless module 112) similarly to the third embodiment. At Step 19, the CPU 132 performs a confirmation of the downloading of the wireless module (first wireless module 111) of the young slot number similarly to the third embodiment. Next, the CPU 132 changes over the wireless module changeover section 160, and performs a confirmation of the downloading of the next wireless module (second wireless module 112) similarly to the third embodiment.

The first to the fourth constructions, when transmitting and receiving, are adapted only to the communication method which does not change an antenna, for example, similarly to the case where a carrier frequency is different according to the transmission and reception similarly to a FDMA. In the case of the communication system where the carrier frequency is the same similarly to a TDMA and the transmission and reception are time-split, the wireless module 200 has an antenna switch at a contact point with an antenna section 210, a reception processing unit 220, and a transmission processing unit 250. The antenna switch changes over the transmission and reception of the antenna 210. The changeover timing is outputted from a digital signal processor 131 of a software signal processing section 130 or the CPU 132.

In the first to fourth constructions, the oscillator 260 exists only in the wireless module 200. The oscillator 260 may exist in the wireless communication device main unit 100. With this arrangement, the wireless communication device main unit 100 can be solely operated even if the wireless module 200 is not connected thereto.

In the first to fourth constructions, the antenna section 210 exists in the wireless module 200. The antenna section 210 may be disposed in the wireless communication device main unit or may use an external antenna. However, in case the external antenna is used as the antenna section, the wireless communication device main unit 100 is constructed to have an antenna connector. Further, the antenna connector is constructed to be connected to the reception processing unit 220 and the transmission processing unit 250 through the connector 110.

The first to fourth constructions have the software signal processing section, and are constructed to be capable of being compatible with a plurality of communication systems. The signal processing section in the wireless communication device main unit is preferable if capable of not only being compatible with a plurality of communication systems by the rewriting of the software, but also being constructed to be capable of being compatible with a plurality of communication systems. For example, it may be constructed in such a manner as to have plural exclusive signal processing sections compatible with a plurality of communication systems in advance, and change the communication system by a parameter.

In the embodiment of the fourth construction, though the wireless communication device main unit 100 has two connectors, it can correspond to three or more connectors and three or more wireless modules. Further, in the embodiment of the fourth construction, though two connectors and two modules are drawn in parallel up and down in the drawing, it is not limited to this arrangement. Further, it does not matter how constructed the wireless module changeover section 160 is, if it is a device not physically connectable, but electrically possible to change a connection.

Although the third construction was described by using the construction connected to the external device capable of downloading software compatible with the communication system to be required, it can correspond also to a construction not connected to the external device capable of downloading similarly to the first construction. In the third embodiment in the present construction, there exists no step involved in the downloading.

Although the fourth construction has been described by using the construction connected to the external device capable of downloading software compatible with the communication system to be required, it can applicable also to a construction not connected to the external device capable of downloading. In the fourth embodiment in the present construction, there exists no step involved in the downloading similarly to the first construction.

Although the fourth construction has been described by using the construction connected to the plural wireless modules compatible with one or more communication systems, it can be also applicable to the construction mounted with a wireless module only applicable to a single communication system and with plural wireless modules applicable to one or more communication systems similarly to the second construction.

In the construction according to the present invention, the AD/DA converter is provided for the wireless communication device main unit. Hence, the wireless module can be set at a low cost and miniaturized. Since a plurality of wireless modules are required to realize a plurality of communication systems, the setting of the cost at a low cost and the miniaturization become possible for the wireless communication device as a total. Further, since a reception filter is provided for the wireless module side, a receiving filer dedicated to each communication system can be designed, thereby making a highly accurate communication. Further, since a transmission processing unit is provided for the wireless module side, a transmitting filer dedicated to each communication system can be designed, thereby making highly accurate communications without unlawful electric waves emitted. Further, by disposing an oscillator at the wireless module side, a high frequency signal can be prevented from deteriorating due to pulling around of the wiring. Further, since communications are made only by the communication system matching to the wireless module, no unlawful electric wave is emitted. Further, since the wireless communication device main unit reconstructs a digital signal processing device based on irregularity information on the high frequency wireless section including transmitting and reception filter characteristics and an antenna, highly accurate communications can be made.

1. A wireless communication device, comprising a wireless communication device main unit including a software processing unit for performing signal processing by a software compatible with a wireless communication system; and a wireless module including a wireless transmitting and reception unit compatible with the wireless communication system, wherein the wireless communication device main unit is equipped with an analogue-digital converter (AD converter) and a digital-analogue converter (DA converter).

2. The wireless communication device according to claim 1, wherein a reception filter for performing a filtering of a received signal is provided in the wireless module.

3. The wireless communication device according to claim 1, wherein a transmission filter for performing a filtering of a transmission signal is provided in the wireless module.

4. The wireless communication device according to claim 1, wherein the wireless module has a storage unit, and the storage unit stores wireless module information at least about a characteristic of the wireless module, and outputs the wireless module information to the wireless communication device main unit.

5. The wireless communication device according to claim 4, wherein the wireless communication device main unit reconfigures the software processing unit based on the outputted wireless module information, and performs a signal processing conforming to the communication system.

6. The wireless communication device according to claim 1, wherein the wireless module is detachable and attachable with the wireless communication device main unit or a plurality of the wireless modules are equipped to the wireless communication device to be changed over therebetween to be usable.

7. A wireless communication device main unit, comprising: a connector section for connecting to a wireless module having a transmission and reception unit comprised of a hardware compatible with a wireless communication system; an AD converter for performing an analogue-digital conversion of a received signal inputted from the connector section; a DA converter for performing a digital-analogue conversion of a transmission signal outputted to the wireless module from the connector section; and a software processing unit for performing a signal processing to the received signal or transmission signal by a software compatible with the wireless communication system.

8. The wireless communication device main unit according to claim 7, wherein the connector section receives an input of the received signal subjected to the filtering in the wireless module.

9. The wireless communication device main unit according to claim 7, wherein the connector section outputs the transmission signal before being subjected to the filtering to the wireless module.

10. The wireless communication device main unit according to claim 7, wherein the software processing unit is reconfigured based on wireless module information showing the characteristic of the wireless module which is read from the wireless module.

11. The wireless communication device main unit according to claim 7, wherein the wireless communication device main unit is connected to the detachable wireless module through the connector section or connected to the plurality of wireless modules through the connector section, any one of which wireless modules is selected, and the software processing unit is reconfigured in accordance with the selected wireless module.

12. A wireless module, comprising: a connector section to be connected with a wireless communication device main unit including a software processing unit for performing a signal processing by a software compatible with a wireless communication system; an antenna section for performing the transmitting and receiving of a wireless signal; a transmission unit for performing a transmitting processing on an analogue transmission signal inputted through the connector section and outputting the signal to the antenna section; a reception unit for performing a receiving processing on the received signal received by the antenna section and outputting the signal to the wireless communication device main unit through the connector section as an analogue received signal; and the transmission unit and reception unit being configured to be compatible with a specific wireless communication system.

13. The wireless module according to claim 12, further comprising a reception filter for performing a filtering on the received signal subjected to the receiving processing.

14. The wireless module according to claim 12, further comprising a transmission filter for performing a filtering on the analogue transmission signal inputted through the connector section.

15. The wireless module according to claim 12, further comprising a storage unit for storing wireless module information showing a characteristic of the wireless module, wherein the storage unit is accessible through the connector section.

16. The wireless module according to claim 12, wherein the wireless module is detachable and attachable with the wireless communication device main unit.

17. The wireless module according to claim 12, wherein plural pieces of the wireless modules are connected to the wireless communication device main unit and used to change over therebetween.
